(19) United States
(12) Patent Application Publication
(10) Pub. No.: US 2009/0025502 A1
(43) Pub. Date: Jan. 29, 2009

(54) Manipulator and robot

(75) Inventor: Hideichi Nakamoto, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/219,700

(22) Filed: Jul. 25, 2008

(30) Foreign Application Priority Data
Jul. 27, 2007 (JP) P2007-196327

(51) Int. Cl. B25J 15/08

(52) U.S. Cl. 74/490.01; 901/31

(57) ABSTRACT

A manipulator includes: a first finger having a sequence of first links and first joint shafts, the sequence of first links bending so that rotation angles of the first joint shafts maintain a fixed relationship; a second finger having a sequence of second links bending sequentially from one of the second links assigned at a basal side of the second finger; and drive sources driving the first and second fingers, wherein an adjacent second link next to the second link assigned at the basal side moves after contacting the second link assigned at the basal side with the object.

### CROSS REFERENCE TO RELATED APPLICATIONS AND INCORPORATED BY REFERENCE

The application is based upon and claims the benefit of priority from the prior Japanese Patent Applications No. P2007-196327, filed on Jul. 27, 2007; the entire contents of which are incorporated herein by reference.

### BACKGROUND OF THE INVENTION

1. Field of the Invention

The present invention relates to a manipulator and a robot for gripping an object.

2. Description of the Related Art

Heretofore, a large number of robot arms and grippers, which perform only a routine task and grip only an object with a definite shape, have been developed. However, in recent years, a service robot provided with arms, which operates at a person's side and assists a person in his/her daily life, has been in a development process. The robot, as described above, must perform not only routine tasks but also tasks corresponding to a variety of situations. Moreover, objects to be handled by the robot have indefinite shapes, and the service robot described above is required to positively grip objects having an indefinite shapes.

Accordingly, a mechanism has been proposed, which drives a plurality of finger joints attached to the gripper by a plurality of actuators and grips the object in accordance with the shape of the object. However, in this mechanism, since a plurality of actuators are used, the mechanism is complicated, and moreover, the weight thereof is also increased. Furthermore, it is complicated to control the plurality of actuators.

A mechanism has been proposed, which integrates, the actuators driving the plurality of joints, and couples the respective joints by a wire to allow the joints to interlock with one another, thereby gripping the object. However, in this mechanism, the respective joints interlock with one another in a completely fixed relationship, and the fingers cannot achieve a posture that goes along a surface shape of the object.

Furthermore, a mechanism has been proposed that uses one actuator and grips the object in a wrapping manner by using clutches arranged in the respective joints. However, in this mechanism, the clutches are arranged in the respective joints, whereby the mechanism becomes complicated, and the weight thereof is also increased. Moreover, the conventional gripper in which the number of actuators has been decreased as much as possible has been incapable of dealing with a variety of shapes of recessed-shaped object such as a bowl, a rod-shaped object such as a chopstick, and the like.

### SUMMARY OF THE INVENTION

An object of the present invention is to provide a manipulator and a robot, which can reliably grip objects of various shapes with a simplified mechanism and control algorithm.

An aspect of the present invention inheres in a manipulator including: a first finger having a sequence of first links and a plurality of first joint shafts connected between the sequence of first links, the sequence of first links configured to bend so that rotation angles of the plurality of first joint shafts maintain a fixed relationship; a second finger provided adjacent to the first finger so as to grip an object with the first finger and having a sequence of second links and a plurality of second joint shafts connected between the sequence of second links, the sequence of second links configured to bend sequentially from one of the second links assigned at a basal side of the second finger; a first drive source configured to drive the first finger; and a second drive source configured to drive the second finger, wherein an adjacent second link next to the second link assigned at the basal side moves after contacting the second link assigned at the basal side with the object.

Another aspect of the present invention inheres in a robot including: a robot body; a plurality of arms attached to the robot body; a plurality of manipulators attached to the arms respectively, each of the manipulators defining grippers including: a first finger having a sequence of first links and a plurality of first joint shafts connected between the sequence of first links, the sequence of first links configured to bend so that rotation angles of the plurality of first joint shafts maintain a fixed relationship; a second finger provided adjacent to the first finger so as to grip an object with the first finger and having a sequence of second links and a plurality of second joint shafts connected between the sequence of second links, the sequence of second links configured to bend sequentially from one of the second links assigned at a basal side of the second finger; a first drive source configured to drive the first finger; and a second drive source configured to drive the second finger; and a control unit configured to control the plurality of manipulators to grip the object, wherein an adjacent second link next to the second link assigned at the basal side moves after contacting the second link assigned at the basal side with the object.

### BRIEF DESCRIPTION OF DRAWINGS

FIG. 1 is a schematic view showing an example of a configuration of a gripper according to a first embodiment of the present invention.

FIG. 2 is a cross sectional view showing a first finger of the gripper according to the first embodiment of the present invention.

FIG. 3 is a cross sectional view showing a second finger of the gripper according to the first embodiment of the present invention.

FIG. 4 is a schematic view for explaining an operation of the gripper according to the first embodiment of the present invention.

FIGS. 5 to 8 are schematic views for explaining a basic operation of the gripper according to the first embodiment of the present invention.

FIGS. 9 to 12 are schematic views for explaining an operation of gripping a recessed-shaped object by the gripper according to the first embodiment of the present invention.

FIGS. 13 to 16 are schematic views for explaining an operation of gripping a slim object by the gripper according to the first embodiment of the present invention.

FIG. 17 is a schematic view showing an arm fitted with the gripper according to the first embodiment of the present invention.

FIG. 18 is a flowchart for explaining a gripping operation by the arm fitted with the gripper according to the first embodiment of the present invention.

FIG. 19 is a schematic view showing a robot according to the first embodiment of the present invention.

FIG. 20 is a schematic view for explaining a gripping operation by the robot according to the first embodiment of the present invention.

FIG. 21 is a flowchart for explaining a gripping operation by the robot according to the first embodiment of the present invention.

FIG. 22 is a cross sectional view showing a gripper according to a second embodiment of the present invention.

FIG. 23 is a cross sectional view showing the gripper according to a second embodiment of the present invention.

FIG. 24 is a cross sectional view showing a gripper according to a third embodiment of the present invention.

FIG. 25 is a cross sectional view showing the gripper according to a third embodiment of the present invention.

FIG. 26 is a cross sectional view showing a gripper according to a fourth embodiment of the present invention.

FIG. 27 is a flowchart for explaining a gripping operation of a gripper according to the fourth embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as it is conventional in the representation of semiconductor devices, it will be appreciated that the various drawings are not drawn to scale from one Figure to another nor inside a given Figure, and in particular that the layer thicknesses are arbitrarily drawn for facilitating the reading of the drawings.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

### First Embodiment

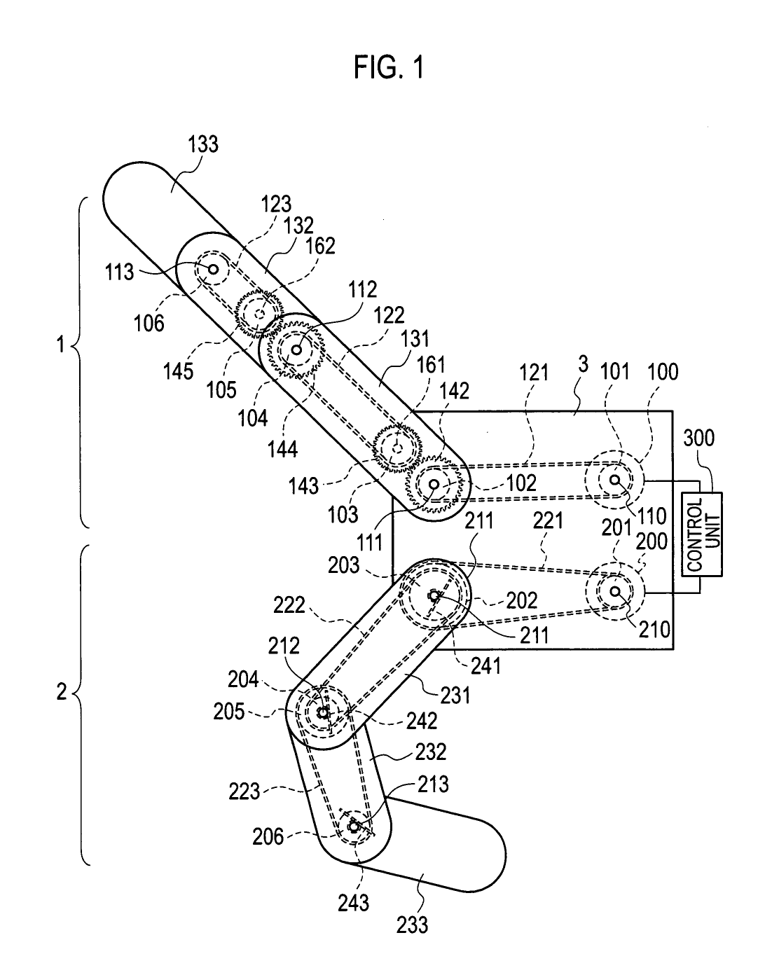

As shown in FIG. 1, a manipulator according to a first embodiment of the present invention is a gripper including: a first finger 1 that has a sequence of links 131, 132 and 133 and a plurality of joint shafts 111, 112 and 113, in which the sequence of links 131, 132 and 133 move (bend) so as to close the first finger 1 in an interlocking manner with one another so that rotation angles of the plurality of joint shafts 111, 112 and 113 can maintain a fixed relationship. The gripper also includes a second finger 2 that is disposed opposite the first finger 1. The second finger 2 also has a plurality of joint shafts 211, 212 and 213 and a sequence of links 231, 232 and 233, in which the sequence of links 231, 232 and 233 move (bend) so as to close the second finger 2 sequentially from the link 231 assigned at a basal side of the second finger 2 thereof, and when the link 231 assigned at the basal side contacts an object, the link 232 adjacent to the link 231 moves in the closing direction. The gripper also includes a plurality (two) of drive sources 100 and 200 which drive the first finger 1 and the second finger 2, respectively.

The first finger 1 and the second finger 2 are attached to a first portion 3. The drive sources 100 and 200 are incorporated in the first portion 3. Actuators are used as the drive sources 100 and 200. Drives of the drive sources 100 and 200 are controlled by a control unit 300.

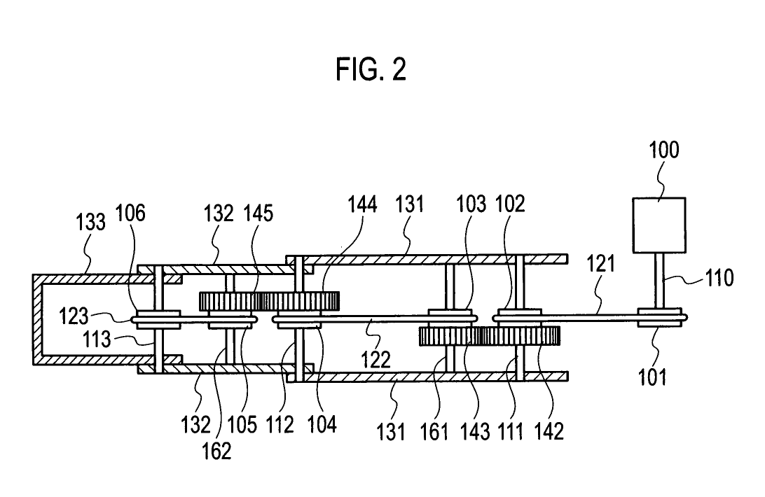

In the first finger 1, as shown in FIG. 2, a pulley 101 is fixed to a drive shaft 110 attached to the drive source 100. The links 131, 132 and 133 are connected to the joint shafts 111, 112 and 113, respectively, so as to be freely rotatable about the joint shafts 111, 112 and 113 as rotation axes of the links. A pulley 102 and a gear 142 integral with the pulley 102 are arranged on the joint shaft 111, and are fixed to the link 131. A rotation shaft 161 is further attached to the link 131 so as to be freely rotatable. On the rotation shaft 161, a transmission mechanism {103, 143} in which a pulley 103 and a gear 143 are integrated is disposed. A pulley 104 and a gear 144 integrated with the pulley 104 are arranged on the joint shaft 112, and are fixed to the link 132. A rotation shaft 162 is attached to the link 132 so as to be freely rotatable, and a transmission mechanism {105, 145} in which a pulley 105 and a gear 145 are integrated is disposed on the rotation shaft 162. A pulley 106 is disposed on the joint shaft 113, and is fixed to the link 133.

The pulley 101 and the pulley 102 are coupled to each other by a timing belt (transmission member) 121, the pulley 103 and the pulley 104 are coupled to each other by a timing belt (transmission member) 122, and the pulley 105 and the pulley 106 are coupled to each other by a timing belt (transmission member) 123.

When the drive source 100 is activated, power from the drive source 100 is transmitted to the pulley 102 by the timing belt 121, and the link 131 integral with the pulley 102 moves so as to close the first finger 1. Moreover, the power is transmitted between the gear 142 integral with the pulley 102 and the transmission mechanism {103, 143} in which the gear 143 and the pulley 103 are integrated. The power is transmitted by the timing belt 122 from the transmission mechanism {103, 143} to the link 132 integral with the pulley 104, and the link 132 moves so as to close the first finger 1. Furthermore, the power is transmitted between the gear 144 integral with the pulley 104 and the transmission mechanism {105, 145} in which the gear 145 and the pulley 105 are integrated. The power is transmitted by the timing belt 123 from the transmission mechanism {105, 145} to the link 133 integral with the pulley 106, and the link 133 moves so as to close the first finger 1. As described above, the rotation shafts 111, 112 and 113 rotate in an interlocking manner while maintaining the rotation angles of the joint shafts 111, 112 and 113 in a fixed relationship.

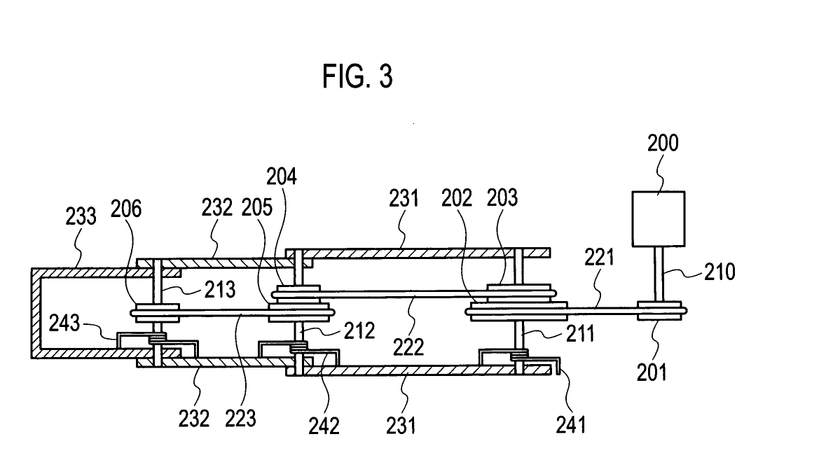

On the other hand, in the second finger 2 shown in FIG. 1 and as further shown in FIG. 3, a pulley 201 is fixed to a drive shaft 210 attached to the drive source 200. A pulley 202 and a pulley 203 integral with the pulley 202 and smaller in diameter than the pulley 202 are freely rotatably connected to the joint shaft 211. A pulley 204 that is smaller in diameter than the pulley 203, and a pulley 205 integral with the pulley 204 and larger in diameter than the pulley 204 are freely rotatably connected to the joint shaft 212. A pulley 206 that is smaller in diameter than the pulley 205 is connected to the joint shaft 213.

The pulley 201 and the pulley 202 are coupled to each other by a timing belt (transmission member) 221, the pulley 203 and the pulley 204 are coupled to each other by a timing belt (transmission member) 222, and the pulley 205 and the pulley 206 are coupled to each other by a timing belt (transmission member) 223. Elastic members 241, 242, and 243 are attached, respectively to the joint shafts 211, 212 and 213, so as to urge the links 231, 232, 233 and open the second finger 2. Springs and the like are usable as the elastic members 241, 242 and 243.

The second finger 2 moves in the closing direction toward the first finger 1 sequentially from the link 231 assigned at the basal side. When the link 231 contacts a surface of the object, the link 232 adjacent to the link 231 moves so as to close the second finger 2. When the link 232 contacts the surface of the object, the link 233 adjacent to the link 232 moves so as to close the second finger 2. As described above, the links 231, 232 and 233 move so as to close the second finger 2 in a configuration that corresponds to the surface shape of an object to be grasped.

Here, to provide a mechanism in which the links move so as to close the second finger 2 sequentially from the link 231, a drive force from the drive source 200 only needs to exceed the urging forces provided by the elastic members 241, 242 and 243 sequentially when the forces of the elastic members 241, 242 and 243 individually exceed the force of the drive source 200. Specifically, in the case where orders of the joint shafts of the second finger 2 are defined sequentially from the joint shaft 111 assigned at the basal side as: n=1, 2, 3 . . . , when diameters of the pulleys are defined as Rₙ, and R₊₁ and elastic moduli of the elastic members are defined as Kₙ and Kₙ₊₁ in the case where the power is transmitted between the n-th joint shaft and the n+1-th joint shaft, the relationships between these characteristics satisfy the following Expression (1):

(Rₙ₊₁/Rₙ)<(Kₙ₊₁/Kₙ) (1)

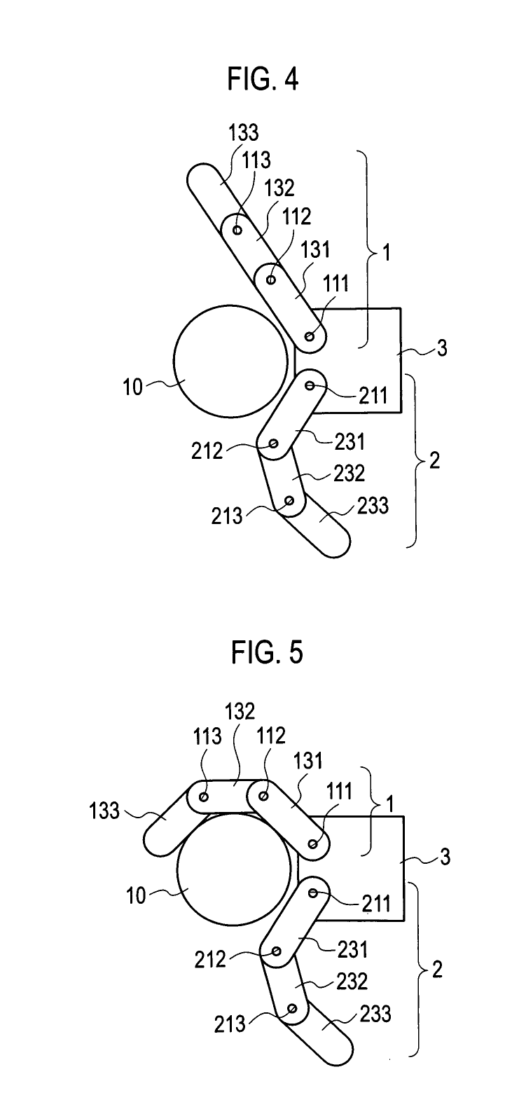

Next, a description will be made of a method of gripping a cylindrical object 10, such as a tumbler, by reference to FIGS. 4 to 8.

As shown in FIG. 4, from a state where the gripper approaches a cylindrical object 10, first, the first finger 1 starts to close while the joint shafts 111, 112 and 113 are interlock with one another at a fixed rotation angle. As shown in FIG. 5, when the first finger 1 starts to contact the object 10, the second finger 2 starts to close.

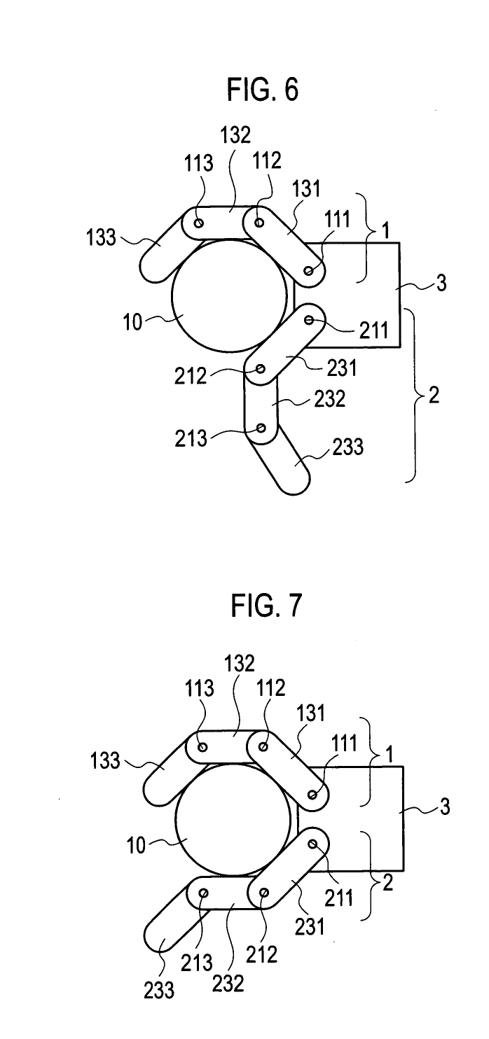

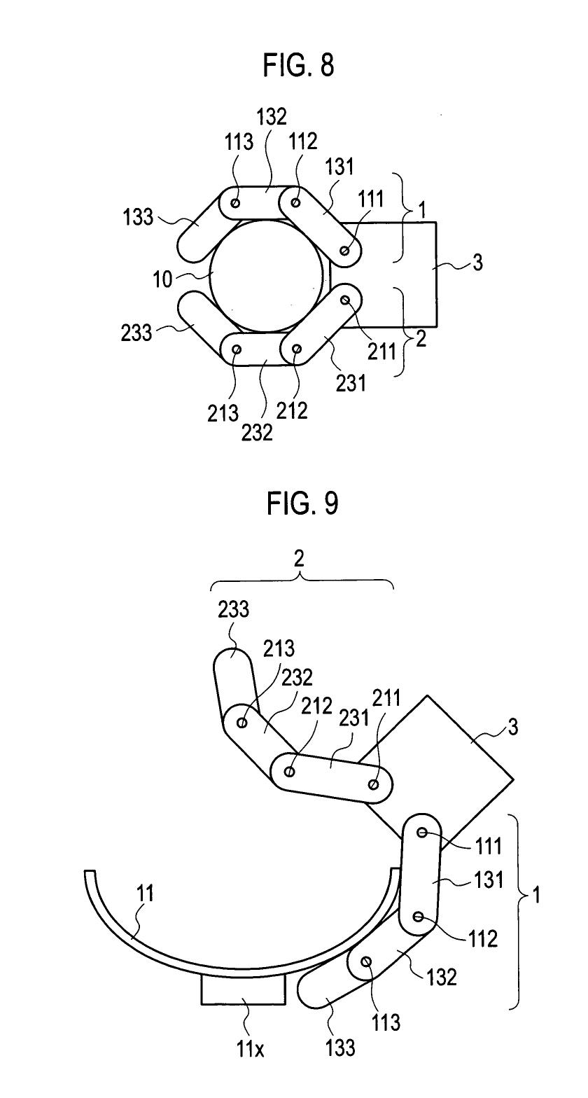

The second finger 2 starts to close first from the joint shaft 211 assigned at the basal side. As shown in FIG. 6, when the link 231 contacts the object 10, the link 232 starts to close. As shown in FIG. 7, when the link 232 contacts the object 10, the link 233 starts to close. As a result, as shown in FIG. 8, the links 231, 232 and 233 of the second finger 2 start to close so as to correspondingly contact a shaped surface of the object 10, and the object 10 is gripped by the first finger 1 and the second finger 2.

As described above, the second finger 2 closes so as to approximately correspond to the shape of the surface of the object 10, and a contact area thereof with the object 10 is increased, and the object 10 can be positively gripped.

Moreover, the first finger 1 in which the joint shafts 111, 112 and 113 interlock with one another at the fixed rotation angle moves to the closed (contact) position in advance of the second finger, so that the object 10 can be supported so as not to separate from the gripper when the second finger 2 closes to contact the object. Accordingly, a situation where the object 10 moves away from the gripper is prevented. Therefore, the object 10 can be positively gripped.

Next, a description will be made of a method of gripping a recessed-shaped object 11 provided with a support portion 11x, such as a bowl, by reference to FIGS. 9 to 12. In FIGS. 9 to 12, the positions of the first finger 1 and the second finger 2 are reversed toward the first finger 1 and the second finger 2 shown in FIG. 1.

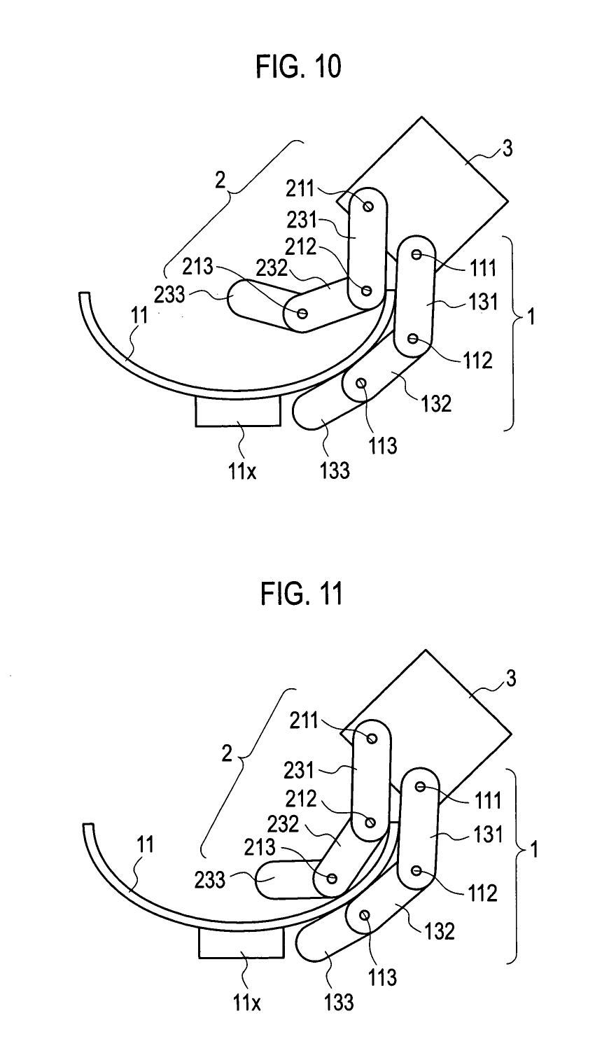

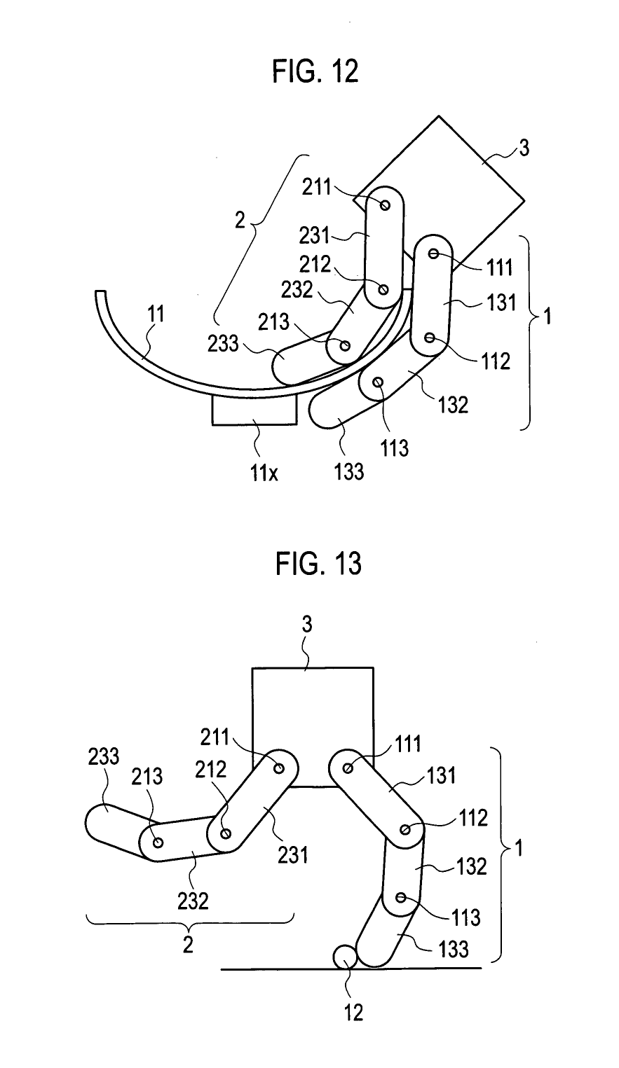

First, as shown in FIG. 9, the first finger 1 closes to a posture along an outside surface of the recessed-shaped object 11. Next, the second finger 2 starts to close from the link 231. As shown in FIG. 10, when the link 231 contacts an inner surface of the recessed-shaped object 11, the link 232 starts to close. As shown in FIG. 11, when the link 232 contacts the inner surface of the recessed-shaped object 11, the link 233 starts to close. As a result, as shown in FIG. 12, the second finger 2 forms a shape that goes along the inside of the recessed-shaped object 11.

As described above, even for the recessed-shaped object 11 that is usually difficult to grip, a contact area of the second finger 2 with the recessed-shaped object 11 can be increased since the second finger 2 forms a shape that goes along with the curved inner surface of the recessed-shaped object 11. Accordingly, the recessed-shaped object 11 can be surely gripped.

Moreover, the second finger 2 has a configuration in which the links 231, 232 and 233 move from the basal side in the closing direction when the second finger 2 contacts the recessed-shaped object 11. Accordingly, an initial posture of the second finger 2 is curved to the outside as shown in FIG. 9, and the second finger 2 starts to close from this state. Therefore, the second finger 2 can be made to go along the surface of the recessed-shaped object 11.

Next, a description will be made of a method of gripping a rod-shaped object 12, such as a chopstick, with reference to FIGS. 13 to 16.

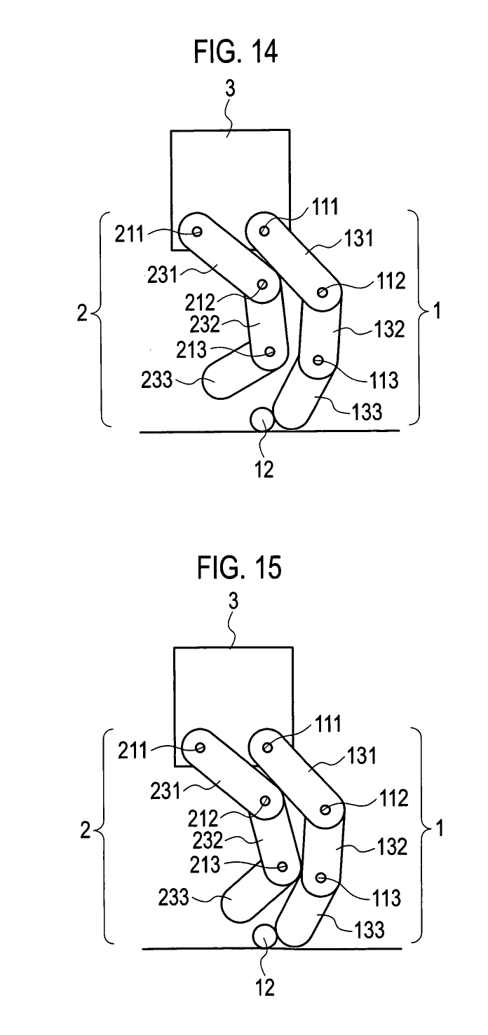

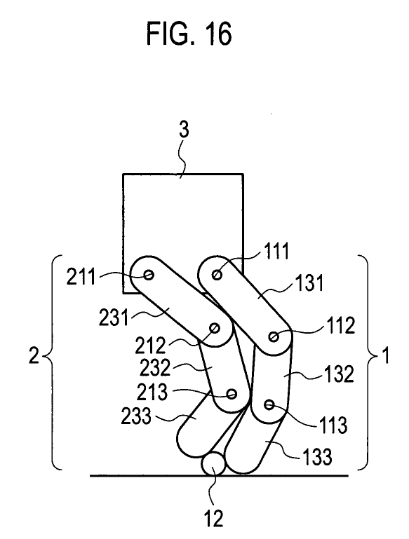

First, as shown in FIG. 13, the first finger 1 closes to a position to contact the stick-like object 12. Next, the second finger 2 starts to close from the link 231. As shown in FIG. 14, when the link 231 contacts the link 131, the link 232 starts to close. As shown in FIG. 15, when the link 232 contacts the link 132, the link 233 starts to close. As a result, as shown in FIG. 16, the object 12 can be sandwiched and gripped by tip ends of the first finger 1 and the second finger 2.

As described above, in accordance with the first embodiment of the present invention, the first finger 1 and the second finger 2 have structures different from each other. In such a way, even while reducing the number of drive sources as much as possible and simplifying the mechanism and a control algorithm, the gripper can surely and stably grip a variety of objects with indefinite shapes, such as the cylindrical object 10, the recessed-shaped object 11 and the rod-shaped object 12, by increasing the contact area thereof with these objects as much as possible.

### (Application to Arm)

A description will be made of an arm with an attached gripper as an example of the manipulator according to the first embodiment of the present invention.

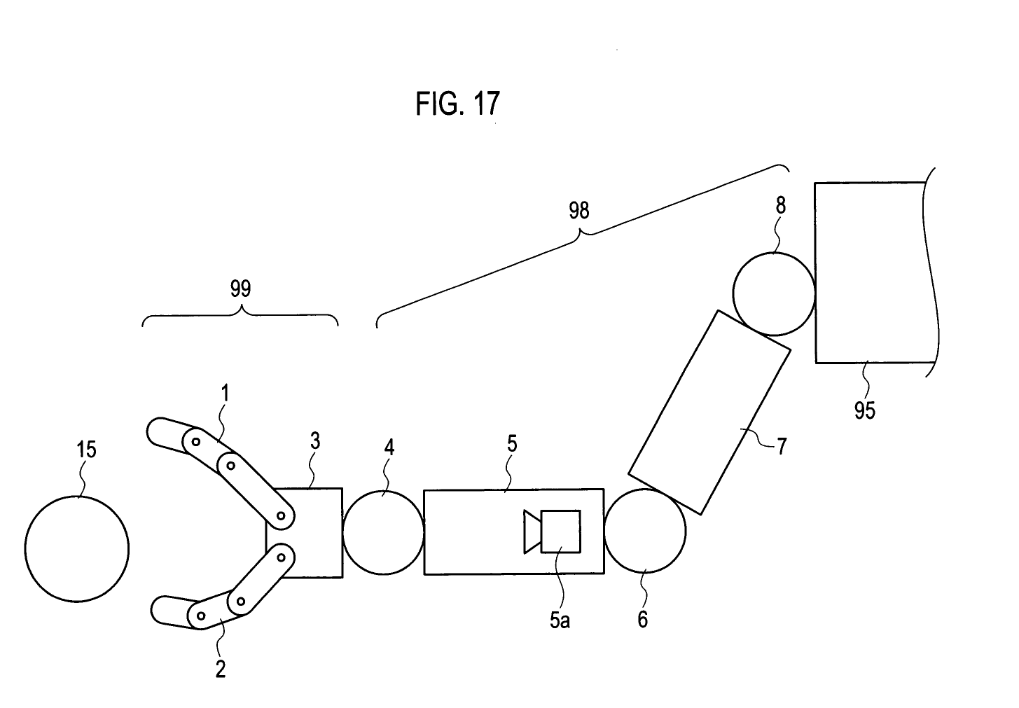

As shown in FIG. 17, an arm 98 and a gripper 99 are attached onto a robot body 95. From the robot body 95 side, the arm 98 has a shoulder joint 8, an upper arm portion 7, an elbow joint 6, a forearm portion 5, and a wrist joint 4. Each of the shoulder joint 8, the elbow joint 6 and the wrist joint 4 has one or a plurality of degrees of rotation freedom. Note that, if the shoulder joint 8, the elbow joint 6 and the wrist joint 4 have a total of six or more degrees of rotation freedom, then the gripper 99 can be brought to an arbitrary position and posture with respect to an object 15 as a target to be gripped. Moreover, a camera 5a is disposed on the forearm portion 5 so as to face toward the gripper 99. The gripper 99 includes the first finger 1, the second finger 2, and the first portion 3.

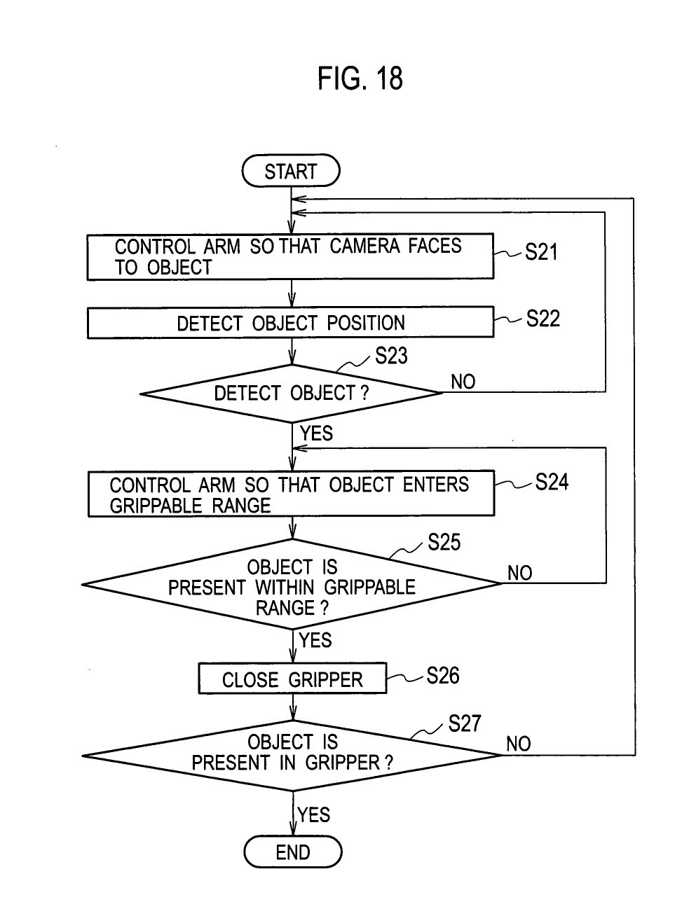

Next, a description will be made of an operation of the arm 98 and attached gripper 99 according to the first embodiment of the present invention while referring to a flowchart of FIG. 18.

In Step S21, the arm 98 is controlled so that the camera 5a can face to where the object 15 as the target to be gripped is supposed to be present. In this case, the shoulder joint 8, the elbow joint 6 and the wrist joint 4 are moved, whereby the camera 5a is faces a direction where the object 15 is supposed to be present. In Step S22, a position of the object 15 is detected based on an image acquired by the camera 5a. As processing for detecting the position, an outline of the object 15 is cut out from the image, or the position of the object 15 is detected based on a color difference in the image.

In Step S23, it is determined whether or not the object 15 has been able to be detected. When it is determined that the object 15 has been detected, the arm 98 is controlled in Step S24 so that the object 15 is within a grippable range of the gripper 99. The “grippable range” refers tp a range where the gripper 99 can grip the object 15 when the gripper 99 closes on the object. In general, a possibility that the gripper 99 can contact and grip the object 15 is increased as the object 15 is located closer to the gripper 99 and more on the center between the first finger 1 and the second finger 2. The arm 98 is controlled by varying the degrees of rotational freedom of the shoulder joint 8, the elbow joint 6 and the wrist joint 4. When it is determined in Step S23 that the object 15 was not detected, the processing returns to Step S21, where the direction of the camera 5a is changed.

In Step S25, it is determined whether or not the object 15 is present within the grippable range of the gripper 99. When it is determined that the object 15 is present within the grippable range of the gripper 99, in Step S26, the gripper 99 is closed, whereby the object 15 is gripped. Finally, in Step S27, it is confirmed by the camera 5a whether or not the object 15 is present in the gripper 99. At this time, the position of the object 15 and the position of the gripper 99 are detected based on the image of the camera 5a, and if the object 15 is present in the gripper 99, then the gripping operation is completed.

In accordance with the first embodiment of the present invention, the gripper 99 can be moved to an appropriate position, and the object 15 can be surely gripped.

### (Application to Robot)

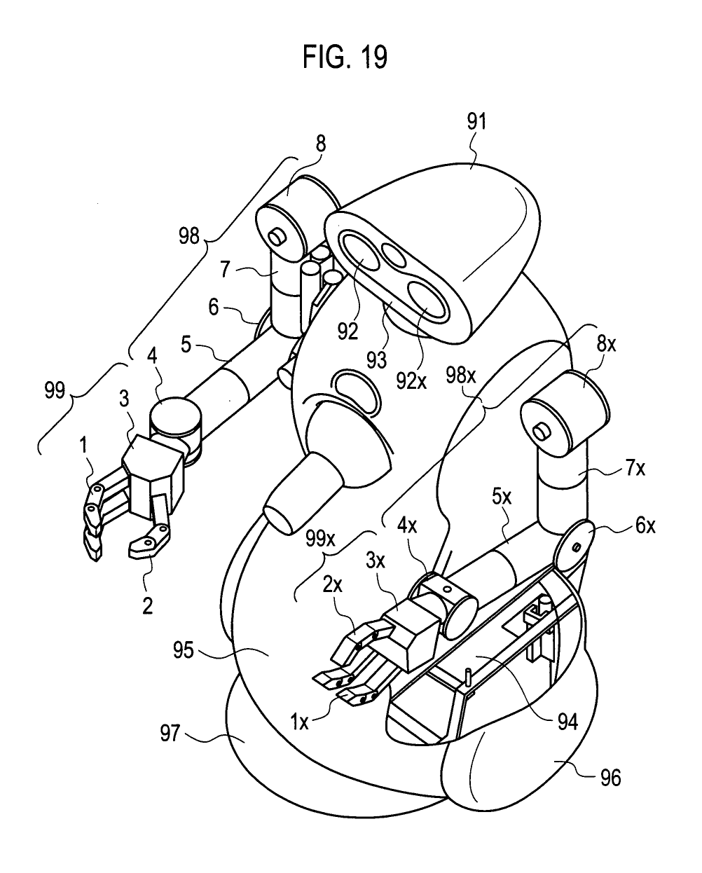

As an application example of the first embodiment of the present invention, a two-arm robot as an example of the manipulator will be described. As shown in FIG. 19, the robot according to the first embodiment of the present invention has a plurality (two) of arms 98 and 98x. The robot can perform a plurality of tasks simultaneously by using the plurality of arms 98 and 98x, and can perform a task while the plurality of arms 98 and 98x cooperating with each other.

A control unit (not shown) is built into the robot body 95. The control unit controls the entire robot including grippers 99 and 99x and the arms 98 and 98x. The entire robot can be moved by a moving mechanism 96. The moving mechanism 96 has, for example, left and right independently driven wheels. The moving mechanism 96 is controlled, whereby the entire robot can move to a target position and posture. Moreover, on a lower position of the robot body 95, a sensor 97 is attached that senses obstacles on the periphery of the robot body 95.

A head unit 91 is disposed on an upper portion of the robot body 95, and is connected to the robot body 95 with a drive mechanism interposed therebetween that changes a direction of the head unit 91. Eyes 92 and 92x are mounted on the head unit 91. By image processing using, for example, a camera and the like, the eyes 92 and 92x detect a position and posture of a task target, and so on in the case where the robot works with the arms 98 and 98x. Moreover, a speaker and a microphone set 93 are attached to the robot, and the robot can communicate with human. The arms 98 and 98x are attached to the robot body 95. The arm 98 includes the shoulder joint 8, the upper arm portion 7, the elbow joint 6, the forearm portion 5, and the wrist joint 4, and the arm 98x includes a shoulder joint 8x, an upper arm portion 7x, an elbow joint 6x, a forearm portion 5x, and a wrist joint 4x. The grippers 99 and 99x are attached to the arms 98 and 98x, respectively. The gripper 99 includes the first finger 1 and the second finger 2, and the gripper 99x includes a first finger 1x and a second finger 2x.

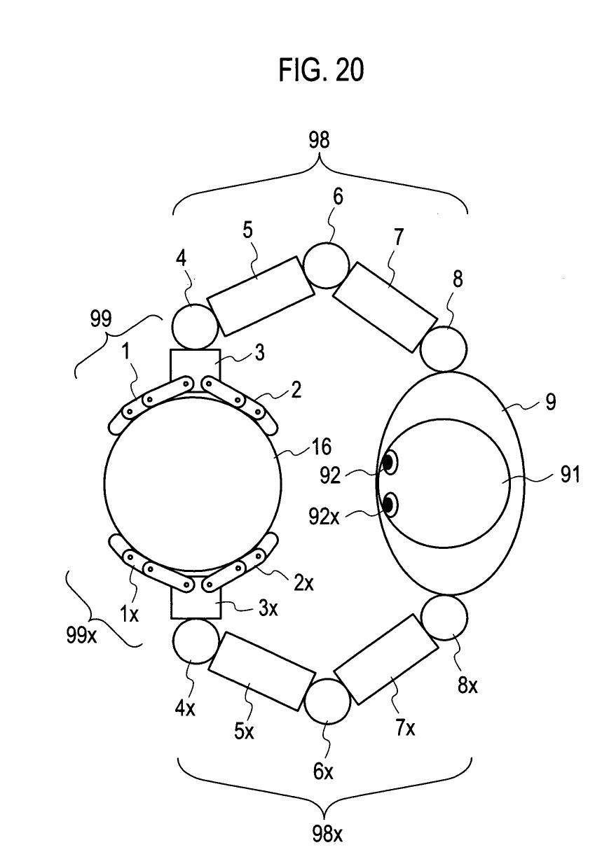

As shown in FIG. 20, in the case of holding a large or heavy object 16, the robot according to the first embodiment of the present invention can grip the object 16 by using the two arms 98 and 98x and the two grippers 99 and 99x.

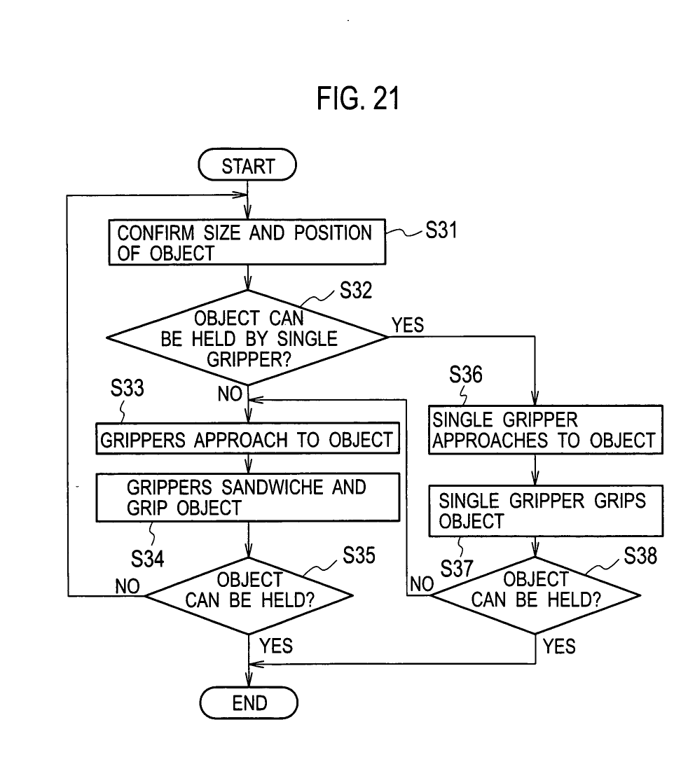

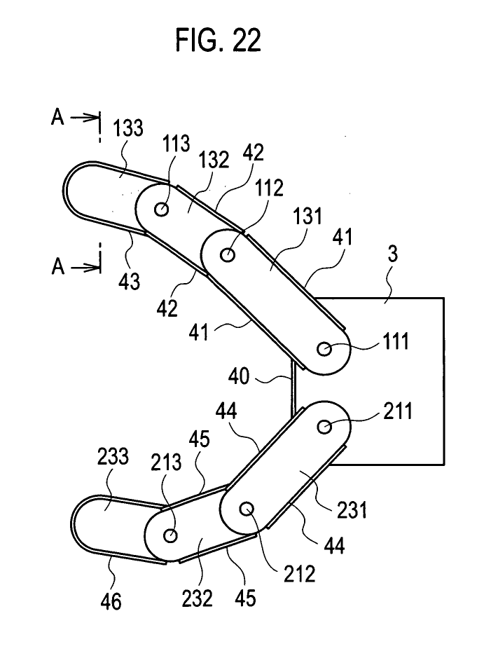

Next, a description will be made of an operation of the manipulator while referring to a flowchart of FIG. 21. In Step S31,the size and position of the object 16, to be gripped, is confirmed by the eyes 92 and 92x mounted on the robot. The object 16 is detected by extracting an outline of the object 16 from a camera image, extracting an image of the object 16 by color detection, and so on.

In Step S32, it is determined whether or not the size of the object 16 detected at this time allows the object 16 to be held by one of the grippers 99 and 99x. When it is determined that the object 16 cannot be held by one of the grippers 99 and 99x, in Step S33, the moving mechanism 96 and the arms 98 and 98x are controlled, whereby the grippers 99 and 99x are made to approach the object 16 from both sides thereof. In Step S34, the object 16 is sandwiched and gripped by the grippers 99 and 99x. In Step S35, it is finally confirmed whether or not the object 16 has been able to be gripped. When it is confirmed that the object 16 has been able to be gripped, the processing is ended. Meanwhile, when the object 16 has not been able to be gripped, the processing returns to a procedure of Step S31.

When it is determined in Step S32 that the size of the object 16 allows the object 16 to be held by one of the grippers 99 and 99x, in Step S36, one of the grippers (for example, the gripper 99) is made to approach the object 16 as the gripping target by using the moving mechanism 96 and the arms 98 and 98x, and in Step S37, the object 16 is gripped by the gripper 99 as one of the pair. When it is confirmed in Step S38 that the object 16 has been able to be gripped, the processing is completed. Meanwhile, when the object 16 has not been able to be gripped, the processing proceeds to Step S33, where the object 16 is gripped by using the two arms 98 and 98x and the two grippers 99 and 99x.

In accordance with the robot according to the first embodiment of the present invention, even for the large or heavy object 16, a contact area of the grippers 99 and 99x with the object 16 can be increased more in such a manner that the two arms 98 and 98x and the two grippers 99 and 99x approach the object 16 from both sides thereof. Accordingly, the object 16 can be surely gripped.

### Second Embodiment

In a second embodiment of the present invention, a description will be made of grippers having soft members are arranged thereon. In order to positively grip an object, the contact area between the object and the grippers is desirably increased as much as possible. However, the contact area cannot be increased sufficiently by only using the links. Accordingly, soft members 41, 42, 43, 44, 45 and 46 are arranged on surfaces of the first finger 1 and the second finger 2. A soft member 40 is also disposed on a surface of the first portion 3 between the first finger 1 and the second finger 2.

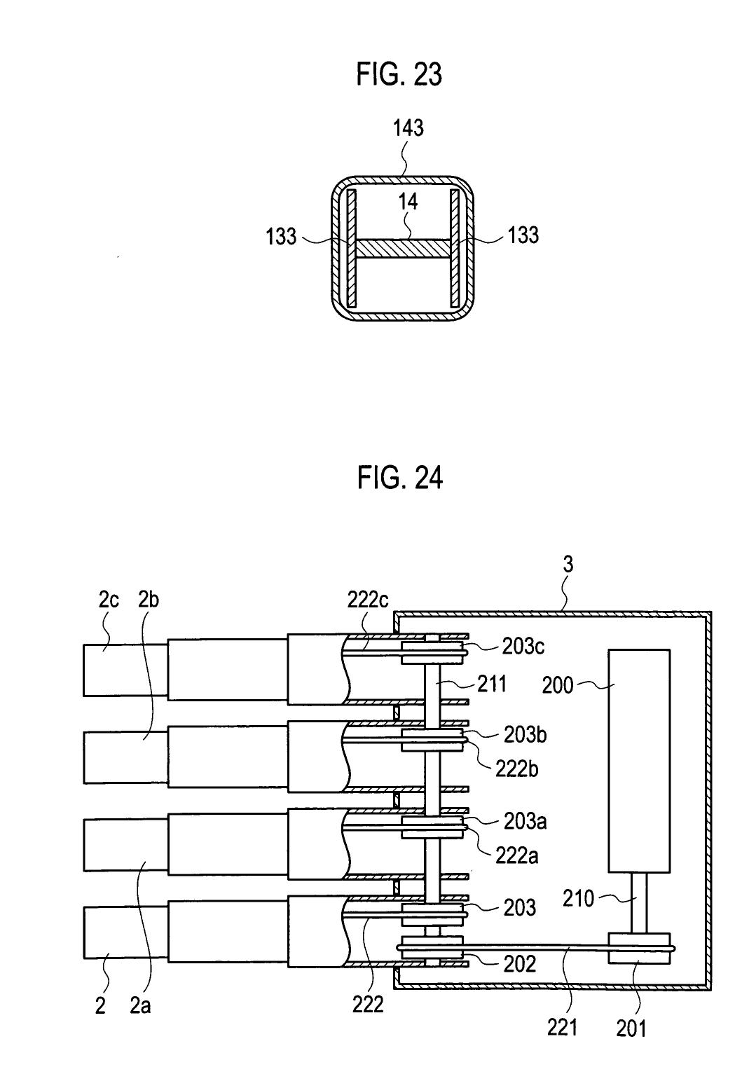

In the first finger 1, as shown in FIG. 23, two side plate members (third links) 133 are joined to a center member 14 by screws and the like (not shown).

In accordance with the second embodiment of the present invention, the soft members 41, 42, 43, 44, 45 and 46 are arranged on the surfaces of the first finger 1 and the second finger 2, thus making it possible to further increase the contact area of the grippers with the object.

Moreover, if a structure such as shown in FIG. 23 is adopted for structures of the first finger 1 and the second finger 2, then strengths of the first finger land the second finger 2 can be ensured, and in addition, the first finger 1 and the second finger 2 will be easy to assemble, and easier to maintain. Moreover, since spaces are formed in the soft members 41, 42, 43, 44, 45 and 46, the soft members will be easy to deform. Furthermore, sensors such as contact sensors can also be arranged in these spaces and used for gripping the object.

Furthermore, in a similar way to the gripper according to the first embodiment, it is possible to attach the gripper according to the second embodiment of the present invention onto the arm.

### Third Embodiment

In a third embodiment of the present invention, a description will be made of a gripper having a plurality of fingers. As shown in FIG. 24, the gripper according to the third embodiment of the present invention includes a plurality of second fingers 2, 2a, 2b and 2c.

The plurality of second fingers 2, 2a, 2b and 2c are driven by the one drive source 200. Drive power is transmitted from the drive source 200 through the timing belt 221 to a second joint shaft (coupling shaft) 211. The power is transmitted from the joint shaft 211 to fingertips of the plurality of second fingers 2, 2a, 2b and 2c through pulleys 202, 203a, 203b and 203c of the plurality of second fingers 2, 2a, 2b and 2c and through timing belts 222, 222a, 222b and 222c of the plurality of second fingers 2, 2a, 2b and 2c.

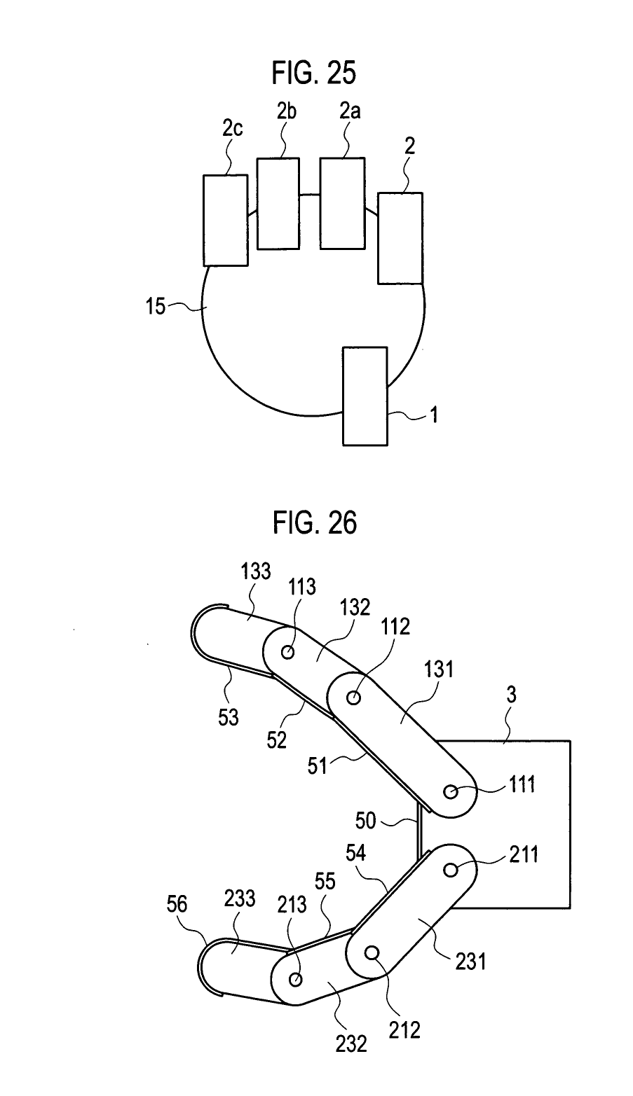

As shown in FIG. 25, an object 15 having a three-dimensional shape can be gripped by using the first finger 1 and the plurality of second fingers 2, 2a, 2b and 2c. Here, if rigidity of each of the timing belts 222, 222a, 222b and 222c is decreased in advance of operation of the fingers, then the plurality of second fingers 2, 2a, 2b and 2c do not move at the same angle but change postures thereof by forces applied individually thereto. Specifically, the plurality of second fingers 2, 2a, 2b and 2c can achieve postures which substantially correspond to the surface shape of the three-dimensional object 15.

In accordance with the third embodiment of the present invention, the three-dimensional object 15 can be gripped more surely. Moreover, since the plurality of second fingers 2, 2a, 2b and 2c are driven by the one drive source 200, the mechanism is not complicated, and the weight is not increased.

Note that, though the description has been made of the plurality of second fingers 2, 2a, 2b and 2c with reference to FIG. 24, a plurality of first fingers 1 maybe provided, or a plurality of both first and second fingers may be provided.

Moreover, in a similar way to the gripper according to the first embodiment, it is possible to attach the gripper according to the third embodiment of the present invention onto the aim of the robot.

### Fourth Embodiment

As a fourth embodiment of the present invention, a description will be made of a gripper with contact sensors attached thereto. As shown in FIG. 26, contact sensors 51, 52 and 53 and contact sensors 54, 55 and 56 are attached onto the surfaces of the first finger 1 and the second finger 2. A contact sensor 50 is also attached onto the surface of the first portion 3 between the first finger 1 and the second finger 2.

The contact sensors 50, 51, 52, 53, 54, 55 and 56 detect contact with an object. Piezoelectric elements and the like are usable as the contact sensors 50, 51, 52, 53, 54, 55 and 56. The contact sensors 50, 51, 52, 53, 54, 55 and 56 are connected to a control unit (not shown). The control unit controls the operations of the first finger 1 and the second finger 2 in response to detection results input by the contact sensors 50, 51, 52, 53, 54, 55 and 56.

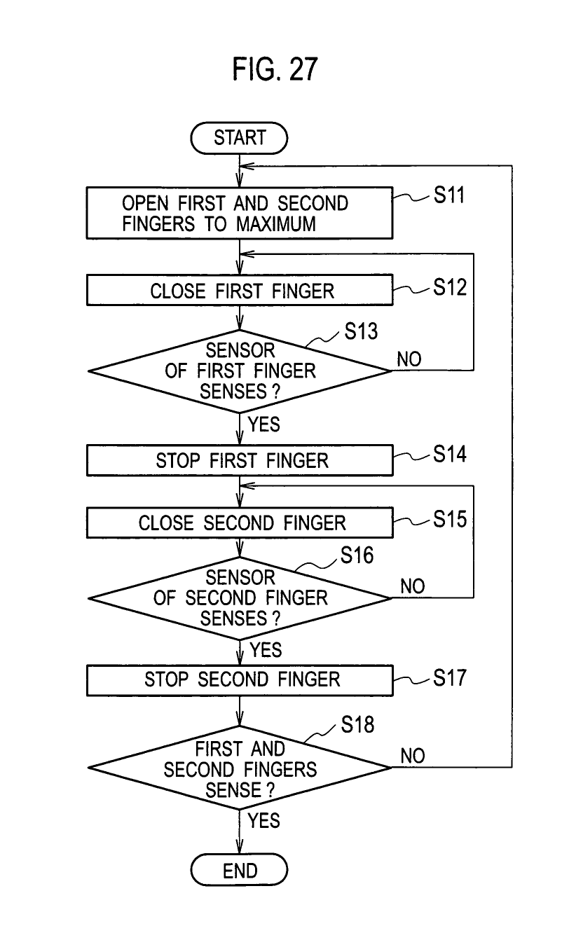

Next, a description will be made of an operation of the gripper shown in FIG. 26 while referring to a flowchart of FIG. 27.

In Step S11, in order to grip the object, the first finger 1 and the second finger 2 are opened to the maximum extent. In Step S12, the first finger 1 moves in the closing direction. In Step S13, when the contact sensor 53 of a fingertip of the first finger 1 produces a response (input to the control unit), it is determined that the first finger 1 has moved into contact with the object, and that the second finger 2 is prepared to make a subsequent motion. Then, in Step S14, the first finger 1 is stopped.

In Step S15, the second finger 2 moves in the closing direction. In Step S16, it is determined whether or not the contact sensor 56 of a fingertip of the second finger 2 produces a response when the second finger 2 closes. When it is determined that the contact sensor 56 produces the response, it is determined that the second finger 2 has also expanded along the surface shape of the object, and that the object has been able to be gripped. Then, in Step S17, the second finger 2 is stopped.

In Step S18, it is finally confirmed whether or not the object has been able to be properly gripped based on whether or not the contact sensor 53 of the first finger 1 and the contact sensor 56 of the second finger 2 have produced responses to the control unit. If both of the contact sensors 53 and 56 have produced the responses, then it is determined that the object has been able to be positively gripped, and the gripping operation is ended. If either of the contact sensors 53 and 56 has not provided a response, then it is determined that the object has not been able to be positively gripped. Then, the processing returns the procedure of Step S11, and the gripping operation is started again.

In accordance with the fourth embodiment of the present invention, the object can be gripped more surely by using the contact sensors 50, 51, 52, 53, 54, 55 and 56.

Note that, in the description referring to FIG. 27, a description has been made of an example of controlling the operation of the gripper in response to detection results of the contact sensors 53 and 56; however, detection results of the other contact sensors 50, 51, 52, 54 and 55 may be used as appropriate.

### Other Embodiments

Various modifications will become possible for those skilled in the art after receiving the teachings of the present disclosure without departing from the scope thereof.

For example, the description has been made of the first finger 1 having the links 131, 132 and 133 and the joint shafts 111, 112 and 113, and of the second finger 2 having the links 231, 232 and 233 and the joint shafts 211, 212 and 213; however, each of the first finger 1 and the second finger 2 just needs to have a multi-joint structure of two or more links and two or more joints.

Moreover, the second finger 2 has a structure in which elastic members with the same elastic force are used, and Expression (1) is satisfied by differentiating the diameters of the pulleys; however, the second finger 2 is not particularly limited as long as the second finger 2 has a structure that satisfies Expression (1). For example, for the second finger 2, a structure may be adopted, in which members with different elastic forces are used as the elastic members 241, 242 and 243, and the diameters of the pulleys are the same.

Furthermore, the respective lengths of the first finger 1 and the second finger 2 are not particularly limited, and are set as appropriate in accordance with a usage purpose and the like of the manipulator.

What is claimed is:

1. A manipulator comprising:
a first finger having a sequence of first links and a plurality of first joint shafts connected between the sequence of first links, the sequence of first links configured to bend so that rotation angles of the plurality of first joint shafts maintain a fixed relationship;
a second finger provided adjacent to the first finger so as to grip an object with the first finger and having a sequence of second links and a plurality of second joint shafts connected between the sequence of second links, the sequence of second links configured to bend sequentially from one of the second links assigned at a basal side of the second finger;
a first drive source configured to drive the first finger; and
a second drive source configured to drive the second finger,
wherein an adjacent second link next to the second link assigned at the basal side moves after contacting the second link assigned at the basal side with the object.

2. The manipulator of claim 1, wherein the second finger further comprises:
a plurality of pulleys disposed at the plurality of second joint shafts respectively;
a plurality of transmission members configured to transmit power between adjacent pulleys; and
a plurality of elastic members disposed at the plurality of second joint shafts and configured to apply power so as to prevent the sequence of first links bending.

3. The manipulator of claim 2, wherein the pulley disposed at the second joint shaft assigned at a tip side is fixed to the second link assigned at a tip side.

4. The manipulator of claim 2, wherein each of the pulleys except the pulley assigned at a tip side is freely rotatable about a corresponding second joint shaft.

5. The manipulator of claim 2, wherein an order of the second joint shafts are defined sequentially from the second joint shaft assigned at the basal side as: n=1, 2, 3 . . . , diameters of the pulleys disposed at an n-th second joint shaft and an n+1-th second joint shaft are defined as Rₙ and Rₙ₊₁ and elastic moduli of the elastic members are defined as Kₙ and Kₙ₊₁, so as to satisfy a relationship of (Rₙ₊₁/Rₙ)<(Kₙ₊₁/Kₘ).

6. The manipulator of claim 1, further comprising a wrist portion to which the first and second fingers are attached.

7. The manipulator of claim 1, further comprising soft members disposed on surfaces of the first and second fingers, respectively.

8. The manipulator of claim 1, wherein the second finger is one of a plurality of second fingers, the plurality of second fingers configured to be driven by the drive source.

9. The manipulator of claim 1, further comprising contact sensors attached to surfaces of the first and second fingers respectively.

10. A robot comprising:
a robot body;
a plurality of arms attached to the robot body;
a plurality of manipulators attached to the arms respectively, each of the manipulators defining gripper comprising:
a first finger having a sequence of first links and a plurality of first joint shafts connected between the sequence of first links, the sequence of first links configured to bend so that rotation angles of the plurality of first joint shafts maintain a fixed relationship;
a second finger provided adjacent to the first finger so as to grip an object with the first finger and having a sequence of second links and a plurality of second joint shafts connected between the sequence of second links, the sequence of second links configured to bend sequentially from one of the second links assigned at a basal side of the second finger;
a first drive source configured to drive the first finger; and
a second drive source configured to drive the second finger; and
a control unit configured to control the plurality of manipulators to grip the object,
wherein an adjacent second link next to the second link assigned at the basal side moves after contacting the second link assigned at the basal side with the object.

11. The robot of claim 10, wherein the second finger further comprises:
a plurality of pulleys disposed at the plurality of second joint shafts respectively;
a plurality of transmission members configured to transmit power between adjacent pulleys; and
a plurality of elastic members disposed at the plurality of second joint shafts and configured to apply power so as to prevent the sequence of first links bending.

12. The robot of claim 11, wherein the pulley disposed at the second joint shaft assigned at a tip side is fixed to the second link assigned at a tip side.

13. The robot of claim 11, wherein each of the pulleys except the pulley assigned at a tip side is freely rotatable about a corresponding second joint shaft.

14. The robot of claim 11, wherein an order of the second joint shafts is defined sequentially from the second joint shaft assigned at the basal side as: n=1, 2, 3 . . . , diameters of the pulleys disposed at an n-th second joint shaft and an n+1-th second joint shaft are defined as Rₙ and Rₙ₊₁ and elastic moduli of the elastic members are defined as Kₙ and Kₙ₊₁, so as to satisfy a relationship of (Rₙ₊₁/Rₙ)<(Kₙ₊₁/Kₘ).

15. The robot of claim 10, wherein the control unit determines whether one of the corresponding manipulator can grip the object,
the control unit configured to control two of the plurality of manipulators to grip the object when the control unit determined that one of the manipulator cannot grip the object.

16. The robot of claim 10, further comprising a wrist portion to which the first and second fingers are attached.

17. The robot of claim 10, further comprising soft members disposed on surfaces of the first and second fingers respectively.

18. The robot of claim 10, wherein the second finger is one of a plurality of second fingers, the plurality of second fingers configured to be driven by the drive source.

19. The robot of claim 10, further comprising contact sensors attached to surfaces of the first and second fingers, respectively.

20. The robot of claim 10, further comprising a camera attached to the arm, the camera configured to obtain an image, and
the control unit determines a position of the object based on the image.
